(19) United States
(12) Patent Application Publication
(10) Pub. No.: US 2026/0212051 A1
(43) Pub. Date: Jul. 23, 2026

(54) Self-locking Data Storage Device

(71) Applicant: Sandisk Technologies, Inc., Milpitas, CA (US)

(72) Inventors: Judah Gamliel Hahn, Ofra (IL); Lip Vui Kan, Singapore (SG); Danny Berler, Tel Mond (IL)

(73) Assignee: Sandisk Technologies, Inc., Milpitas, CA (US)

(21) Appl. No.: 19/034,529

(22) Filed: Jan. 22, 2025

(51) Int. Cl. G06F 21/79; G06F 21/60

(52) U.S. Cl. CPC G06F 21/79; G06F 21/602; G06F 21/604

(57) ABSTRACT

A data storage device includes a non-volatile storage medium configured to store data. The non-volatile storage medium is configurable to include logical storage spaces that include a protected logical storage space that is inaccessible at power-up of the data storage device. The data storage device further includes a communication interface configured to enable communication with a host device; and at least one controller configured, individually or in combination, to: communicatively couple with the host device; and conditional on data provided by the host device based on a secret, provide access to the protected logical storage space. The protected logical storage space becomes inaccessible in response to a trigger event.

### TECHNICAL FIELD

This disclosure relates to a data storage device.

### BACKGROUND

Data storage devices are electronic devices with the capability to store information in the form of digital data. Data storage devices are typically deployed as an integrated part of, or as a removable component configured to interface with, a computing system for the purpose of improving the data transmission and storage capabilities of the system. From the perspective of the computing system, a data storage device is typically implemented as a block storage device where the data stored is in the form of one or more blocks, being sequences of bytes or bits having a maximum length, referred to as block size.

Data storage devices are commonly used to supplement the data storage capabilities of a computer system. For example, external data storage devices are often standalone physical devices which house an internal storage component, such as a hard disk drive (HDD) or a solid-state drive (SSD), that provides a host computing system with an additional portion of non-volatile memory (i.e., the volume of the drive) in which to store digital data. These external drive type devices are connectable to the host computer system via a data path operating over a particular connectivity protocol (e.g., via Universal Serial Bus (USB) cable). In response to being connected to the host computer system, the host computer system recognizes the drive as a block data storage device such that a user of the device may access the storage of the drive via the data path (e.g., through operation of the host computer). Access to the drive typically enables a user to access (e.g., read, write and/or modify) user data stored on the drive.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Disclosed herein is a data storage device. In particular, some embodiments of the disclosed data storage device provide a “locking mechanism” to ensure protected resources stored on the data storage device are accessible to a host device and inaccessible to other devices, such as a user device or unauthorized devices.

According to an aspect of the present disclosure, there is provided a data storage device comprising:
a non-volatile storage medium configured to store data, the non-volatile storage medium being configurable to comprise logical storage spaces, the logical storage spaces comprising a protected logical storage space that is inaccessible at power-up of the data storage device;
a communication interface configured to enable communication with a host device; and
at least one controller configured, individually or in combination, to:
   communicatively couple with the host device; and
   conditional on data provided by the host device based on a secret, provide access to the protected logical storage space,
      wherein the protected logical storage space becomes inaccessible in response to a trigger event.

It may be an advantage that the protected logical storage space becomes inaccessible in response to a trigger event, as this may prevent unauthorized users from accessing protected resources stored within the protected logical storage space. This is useful in situations where a host utilizes the protected resources, and the data storage device is then provided to an end-user.

In some embodiments, the trigger event is power-down of the data storage device.

In some embodiments, the trigger event is one of:
a reset of the controller;
transferring control to an operating system (OS); and
receiving user input data.

In some embodiments, the at least one controller is further configured to configure the data storage device into one of multiple device states, each of the multiple device states being indicative of access to one or more of the logical storage spaces.

In some embodiments, multiple device states comprise a hidden device state where the protected logical storage space is read-and-write accessible.

In some embodiments, the hidden device state is non-transient.

In some embodiments, the multiple device states comprise a user device state where the one or more of the logical storage spaces are read-only accessible.

In some embodiments, the multiple device states comprise an admin device state where the each of the logical storage spaces are read-and-write accessible.

In some embodiments, the logical storage spaces comprise a default logical storage space indicative of manufacturing default conditions of the data storage device, and the multiple device states comprise a default device state where the default logical storage space is accessible and the protected logical storage space is inaccessible.

In some embodiments, the data storage device is configured into the default device state in response to the trigger event.

In some embodiments, the multiple device states are device personalities.

In some embodiments, the logical storage spaces are namespaces.

In some embodiments, the non-volatile storage medium comprises a cryptographic key and the secret is based on the cryptographic key.

In some embodiments, the cryptographic key is one of multiple cryptographic keys each associated with one of multiple device states of the data storage device; and the at least one controller is further configured to configure the data storage device into one of multiple device states associated with the cryptographic key.

In some embodiments, non-volatile storage medium is configured to store data on the protected logical storage space in a form as received from the host device.

In some embodiments, the non-volatile storage medium is a solid-state drive (SSD).

In some embodiments, the communication interface is configured to communicate with the host device according to NVMe.

According to an aspect of the present disclosure, there is provided a method performed by at least one controller of a data storage device, the method comprising:
communicatively coupling with a host device; and
conditional on data provided by the host device based on a secret, providing access to a protected logical storage space, the protected logical storage space being a logical storage space of a non-volatile storage medium of the data storage device and being inaccessible at power-up of the data storage device,
   wherein the protected logical storage space becomes inaccessible in response to a trigger event.

According to an aspect of the present disclosure, there is provided a non-transitory computer-readable medium for securing a data storage device comprising a non-volatile storage medium configured to store data, the non-transitory computer-readable medium comprising instructions that, when executed by one or more controllers, cause one or more controllers of the data storage device to perform, individually or in combination, operations comprising:
communicatively coupling with a host device; and
conditional on data provided by the host device based on a secret, providing access to a protected logical storage space, the protected logical storage space being a logical storage space of a non-volatile storage medium of the data storage device and being inaccessible at power-up of the data storage device,
   wherein the protected logical storage space becomes inaccessible in response to a trigger event.

According to an aspect of the present disclosure, there is provided a data storage device comprising:
means for storing user data and means for configuring logical storage spaces of the data storage device, the logical storage spaces comprising a protected logical storage space that is inaccessible at power-up of the data storage device;
means for communicatively coupling with a host device;
means for providing access to the protected logical storage space, conditional on data provided by the host device based on a secret; and
   wherein the protected logical storage space becomes inaccessible in response to a trigger event.

### BRIEF DESCRIPTION OF DRAWINGS

A non-limiting example will now be described with reference to the following drawings, in which:

FIG. 1 illustrates an example system, according to an embodiment of the present disclosure.

FIG. 2a illustrates an example embodiment of a method performed by at least one controller of a data storage device.

FIG. 2b illustrates another example embodiment of a method performed by at least one controller of a data storage device.

FIG. 3 illustrates another example system, according to an embodiment of the present disclosure.

FIG. 4 shows a flowchart of interactions between a host device and an embodiment of the data storage device, according to the present disclosure.

### DESCRIPTION OF EMBODIMENTS

Disclosed herein is a data storage device with a non-volatile storage medium comprising a protected logical storage space for storing protected resources. Access to this protected logical storage space may be implemented in a controlled manner, and the protected logical storage space may store data or features that are not made available to the general user operating system (OS). Moreover, the disclosed data storage device may be provided with a locking mechanism to prevent (or disable) access to the protected logical storage space in response to an event that would otherwise perpetuate access to the protected logical storage space. For example, the disclosed data storage device may automatically lock itself on power cycle. Alternatively, or additionally, this locking mechanism may occur in response to an event where the data storage device is no longer in a secured or trusted state. For example, decoupling of the data storage device from a trusted host device. Hence, the disclosed data storage device may be considered to be a self-locking data storage device.

Access to the protected logical storage space and visibility of the space may be provided in a trusted environment, such as the Original Equipment Manufacturer (OEM) manufacturing facility and/or the basic input/output system (BIOS) of a host device (e.g., a trusted entity). As such, this can be used to enable access to data without exposure to the untrusted OS, thereby preventing access to the protected logical storage space except when a trusted entity requests this.

The disclosed data storage device may protect hidden data in different situations. One particular problem for device manufacturers who use data storage devices in their devices (such as laptops, for example) is that part of the memory may be used to contain hidden data, such as secure data, sensitive data or other types of protected resources. Such protective resources should remain inaccessible from the end-user e.g., consumers, and it can be difficult for the device manufacturers to utilize the protected resources while isolating these resources from the end-user.

Protected resources may also be used to secure client compute devices, for example. The protected resources used for this purpose should be segregated and shielded from untrusted software, i.e., anything that runs on top of an OS. One way to address this is to house this data in a device that is not addressable by the OS, but this approach leads to higher Bills of Materials (BOM) cost, and complexity in maintaining and updating the secured software. Some secure devices may use encryption with multiple keys to address this. However, this is not suitable for all situations, as self-encrypting drives are export-controlled and have a higher end-user cost.

In one example, for some data storage devices, access to the hidden data is provided in a non-transient matter, in the sense that access to the hidden data is permanent. This means that an end-user may be able to access the hidden data if they obtain the data storage device in this non-transient state. In some cases, the part of the memory may be detached before the BIOS hands off control to the OS, and the data storage device may prevent the part of the memory from being accessible by the OS. In Non-Volatile Memory express (NVMe), for example, the Lockdown feature may be used to prevent the logical storage space from being accessible by the OS, to segregate and shield the hidden data from untrusted software. However, nothing prevents the user from moving the data storage device to a different host and accessing the part of the memory, thus exposing the hidden data. In some situations, to change the accessibility of the data storage device, the data storage device manufacturer would need to reconfigure the device.

The proposed locking mechanism addresses this. Further, the disclosed data storage device does not require encryption, but provides a level of security that addresses different situations. In essence, the disclosed data storage device enables segregated storage of secure data in a single storage device, while preventing an untrusted entity (such as an attacker) from accessing this data.

In the following detailed description, various aspects of a data storage device in communication with a host device will be presented. These aspects are suited for flash storage devices, such as SSDs (solid-state drive) and SD (Secure Digital) cards. However, these aspects may be extended to other types of data storage devices capable of storing data. In yet further examples, the data storage device can be a combination of flash memory and magnetic storage such as a hybrid drive. Accordingly, any reference to a specific apparatus or method is intended only to illustrate the various aspects of the present disclosure, with the understanding that such aspects may have a wide range of applications without departing from the spirit and scope of the present disclosure.

### Overview

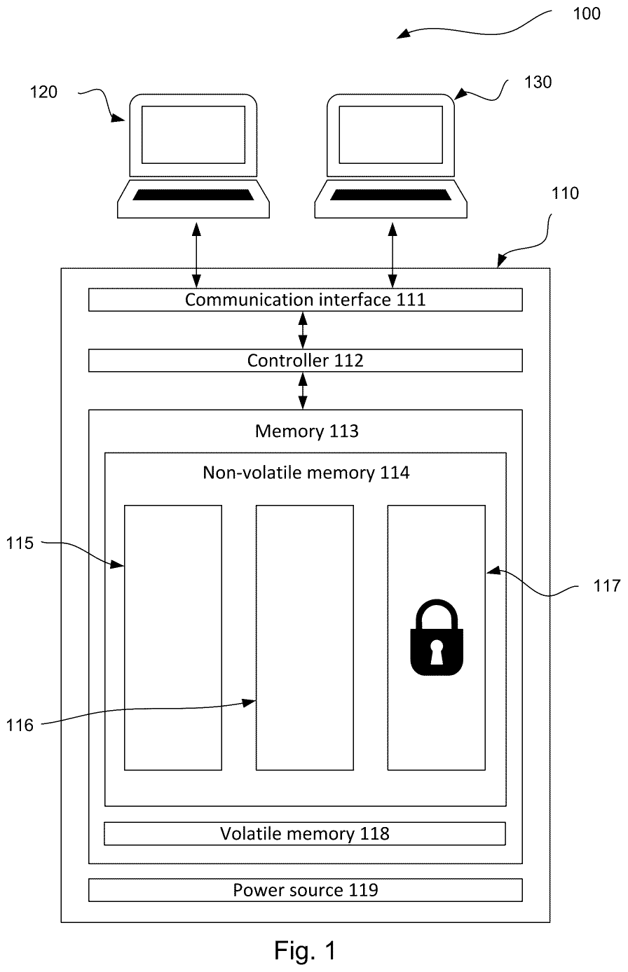

FIG. 1 illustrates an example system 100, according to an embodiment of the present disclosure. FIG. 1 is one example of a configuration of system 100. However, system 100 is not strictly limited to this configuration and this may be one possible embodiment of system 100. It is noted that system 100 of FIG. 1 is only meant to illustrate an example system which is capable of performing the disclosed method.

System 100 comprises data storage device 110. Data storage device 110 comprises communication interface 111, controller 112, memory 113 which comprises non-volatile memory 114 (i.e., a non-volatile storage medium) and volatile memory 118. Controller 112 is configured to execute program code stored within memory 113 to issue commands for controlling the operation of data storage device 110.

Non-volatile memory 114 is configured to store data. As will be explained later in this disclosure, non-volatile memory 114 is configurable to comprise logical storage spaces 115, 116, 117 including protected logical storage space 117 that is inaccessible at power-up of data storage device 110. Data storage device 110 also comprises power source 119. These components will be described in greater detail below.

System 100 comprises host device 120. Host device 120 and data storage device 110 may communicatively couple, such that controller 112 communicatively couples to host device 120 via communication interface 111. As such, host device 120 and data storage device 110 may form part of a computer system (e.g. server, desktop, laptop, tablet, smartphone, etc.). In this illustrated example, the components of FIG. 1 are physically co-located. However, in other examples, host device 120 may be located remotely from the data storage device 110. System 100 comprises user device 130, which may similarly communicatively couple to data storage device 110. Communication interface 111 is configured to communicate with host device 120 and user device 130, which in some examples includes a universal serial bus (USB) bridge configured to transmit and receive data via a USB cable to host device 120.

### Hardware

### Data Storage Device

FIG. 1 illustrates a schematic of data storage device 110, which may communicatively couple to host device 120 and/or user device 130. Data storage device 110 may be connected to communicate with host device 120 and/or user device 130, such as via a physical data cable. Data storage device 110 may be a data storage device in the form of a portable device that can be used (at separate times) with more than one host device. In some examples, data storage device 110 may be in wireless communication with host device 120 and/or user device 130, either directly, or via a communications network (not shown). Data storage device 110, in some examples, is a portable data storage device utilizing flash memory storage as the memory 113. Data storage device 110 may be an external storage device such as, but not limited to, a hard disk drive (HDD), a solid-state drive (SSD) or a USB flash drive. Data storage device 110 may be an integrated device within a computer case, such as a desktop or laptop computer and may be connected by NVMe, Serial AT Attachment (SATA), or other connection types.

### Controller

Data storage device 110 comprises controller 112 that may include one or more processing devices configured, individually or in combination, to perform one or more operations on data storage device 110. Controller 112 (or the one or more processing devices thereof) may be similar or equivalent to a processor, such as a central processing unit (CPU), graphics processing unit (GPU) or a micro-processor, micro-controller or controlling circuitry and may run without operating system, with an operating system, microkernel or other technologies. Controller 112 may perform one or more operations on data storage device 110, including executing instructions from firmware and/or to perform operations on the data storage device 110. Data storage device 110 may be configured so that controller 112 is part of the data path from memory 113 to host device 120.

Software, that is, an executable program stored on non-volatile memory 114 causes controller 112 to perform one or more operations on data storage device 110. While the singular of “controller” is used herein, it is meant to also encompass multiple controllers that are individually or together configured (e.g., programmed) to perform the methods disclosed herein. As such, controller 112 may refers to multiple central processing units (CPUs) and/or graphical processing units (GPUs) that are configured to collectively perform the methods disclosed herein.

Once executed, the software may cause controller 112 to (and hence, controller 112 may be configured to) communicatively couple with host device 120; and conditional on data provided by host device 120 based on a secret, provide access to protected logical storage space 117, wherein protected logical storage space 117 becomes inaccessible in response to a trigger event.

### Communication Interface

Data storage device 110 comprises communication interface 111, which is configured to facilitate communication between data storage device 110, host device 120 and/or user device 130. This can include hardware components, such as connectors and input and output circuits to enable a physical cable, such as a universal serial bus (USB), SATA, Peripheral Component Interconnect Express (PCIe), or Ethernet cable to connect and communicate between the between data storage device 110, host device 120 and/or user device 130. In some examples, communication interface 111 may facilitate communication between data storage device 110, host device 120 and/or user device 130 through wireless communication, such as through Wi-Fi according to the IEEE 802.11 standard, the Internet or Bluetooth.

In some examples, communication interface 111 enables communication via a USB (Universal Serial Bus) standard cable and connector. This can include one or of the USB-A, USB-B, USB-C standards. In some examples, the USB cable has ends including one or more of the following connectors: USB-A; USB-B; Mini-USB B; Micro-USB B; Micro-USB 3.0; USB-C; Thunderbolt 1; and Thunderbolt 2. In other examples, this can include a communication interface to enable communication via eSATA (external serial advanced technology attachment), and eSATAp (power over eSATA), standards. In yet other examples, this can include a communication interface to enable communication via Fire Wire standards. In yet further examples, this can include a communication interface to enable communication via Thunderbolt standards.

In some examples, communication interface 111 is configured to communicate with host device 120 and/or user device 130 according to the Non-Volatile Memory Express (NVMe) specification or the Non-Volatile Memory Host Controller Interface Specification (NVMHCIS) specification. In particular, communication interface 111 may connect data storage device 110 to a network of NVMe over Fabrics (NVMe-oF). This may include a switch fabric network topology. Used in this context, a “fabric” enables any-to-any connections among elements. A fabric may be distinguished from a network, which may restrict the connections possible among the attached elements.

### Non-Volatile Storage Medium

Data storage device 110 comprises non-volatile memory 114 (i.e., non-volatile storage medium) configured to store data. Non-volatile memory 114 is a non-transitory computer readable medium and may be an optical disk drive, a rotating magnetic disk as in a hard disk drive (HDD), a NOT-AND (NAND) Flash medium as in a solid-state Drive (SSD), or an emerging memory device, such as Magnetic Random Access Memory (RAM), Phase Change Memory or Resistive RAM. Non-volatile memory 114 may be variations of SSD like Serial ATA (SATA), mini-SATA (mSATA), M.2 and NVMe or solid-state hybrid drive (SSHD). Other storage media may be used, or another equivalent type of memory. Non-volatile memory 114 may comprise a plurality of blocks, where each block is the smallest unit that can be erased. Each block contains a plurality of flash memory units (FMU), where the FMU is the smallest data chunk that the can be used to read or write to the flash memory. Because each block is the smallest unit that can be erased, to erase or modify data in one FMU involves erasing at least an entire block and rewriting the block (or to a new block).

Non-volatile memory 114 is configurable to comprise logical storage spaces 115, 116, 117. In the context of the present disclosure, “logical storage spaces” may refer to virtual areas of usable storage space on a physical storage device. They may be created by dividing a physical drive into logical volumes and may be treated as separate entities by the OS. In a sense, logical storage spaces may be thought of as partitions of the non-volatile memory 114. However, logical storage spaces are distinct from physical partitions of the non-volatile memory 114. Moreover, in some examples, each of the logical storage spaces (such as logical storage spaces 115, 116, 117) may be associated with an individual (or unique) identifier and/or address.

“Configurable” is this context may refer to the one or more logical storage space being creatable, modifiable or deletable on non-volatile memory 114. As such, controller 112 may be configured to create, modify or delete one or more of logical storage spaces 115, 116, 117. While non-volatile memory 114 comprises three logical storage spaces as depicted in FIG. 1, it is noted that non-volatile memory 114 may comprise any number of logical storage spaces. In another embodiment of the data storage device of the present disclosure, non-volatile memory 114 may comprise two logical storage spaces, where one of the two logical storage spaces is a protected logical storage space.

According to the present disclosure, logical storage spaces 115, 116, 117 comprise a protected logical storage space (denoted as protected logical storage space 117) that is inaccessible at power-up of data storage device 110. Protected logical storage space 117 may be configured to store data such as protected resources (e.g., data that is to be inaccessible to some users of data storage device 110). For example, protected logical storage space 117 may be configured to store data that is to be hidden from a user (e.g., a user associated with user device 130), but accessible by a host (e.g., a user associated with host device 120). Such protected resources may include secure data, sensitive data or device features.

Non-volatile memory 114 may comprise configuration data that defines the one or more of the logical storage spaces. In some embodiments, the configuration data that defines one or more of the logical storage spaces is non-transient. In particular, in some embodiments, the configuration data that defines protected logical storage space 117 is non-transient. This may mean that non-volatile memory 114 stores and maintains these logical storage spaces (and any data stored on the associated logical storage spaces) even if data storage device 110 is re-configured into a different device state (as will be discussed later in the disclosure), data storage device 110 powers down, data storage device 110 decouples from host device 120 and/or user device 130. Conversely, the configuration data defining one or more of the logical storage spaces may be transient, in the sense that the device state vanishes or is “forgotten” if data storage device 110 is re-configured into a different device state, data storage device 110 powers down, data storage device 110 decouples from host device 120 and/or user device 130.

In some embodiments, the non-volatile storage medium (e.g., non-volatile memory 114) is configured to store data on protected logical storage space 117 in a form as received from host device 120. In other words, controller 112 may store data in the same data format and data type as received from host device 120. This is to say that, in some embodiments, controller 112 does not perform any data augmentation (such as compression) or encryption to the data received from host device 120 before storing the received data. In this sense, some embodiments described herein may be distinct from encrypted partitions as encrypted partitions are always accessible, whereas protected logical storage space 117 is inaccessible in response to the trigger event (as will be discussed). It is noted that the data from host device 120 may still be encrypted data that has been encrypted by host device 120 or elsewhere outside data storage device 110. However, data storage device 110 stores the data as it is received (encrypted or not) and does not apply any further encryption. This way, the hardware and power requirements of data storage device 110 are reduced while still providing a level of security by way of protected logical storage space 117.

In some embodiments, the logical storage spaces are namespaces. For example, the logical storage spaces may be namespaces according to NVMe. A namespace, as defined by the NVMe specification, is a collection of non-volatile memory (NVM) sectors that can be independently managed and utilized by the system. Each namespace functions as a separate storage space, enabling fine-grained control over data storage and retrieval operations. More specifically, a namespace is a collection of logical block addresses (LBA) accessible to host software. A namespace ID (NSID) is an identifier used by a controller to provide access to a namespace. A namespace is not the physical isolation of blocks, rather the isolation of logical blocks addressable by the host software. Namespace may be useful for different situations: for logical isolation, multi-tenancy, security isolation (encryption per namespace), write protecting a namespace for recovery purposes, overprovisioning to improve write performance and endurance etc.

Unlike partitions, which are fixed divisions of a physical storage medium, namespaces are logical constructs that can be dynamically allocated, resized, and managed without altering the underlying physical structure of the data storage device. This capability of namespaces enables greater flexibility and scalability in managing storage resources, particularly in environments that require high performance and reliability. Furthermore, namespaces can support advanced features like quality of service (QoS) and multi-tenancy, enabling multiple users or applications to securely and efficiently share the same physical storage hardware while maintaining isolation and performance guarantees. The ability to create, modify, or delete namespaces independently, without impacting other namespaces, provides advantages over partitioning.

It is noted that providing access to a namespace may be referred to as “attaching” or more specifically, “attaching the namespace”. For example, providing access to a namespace may be considered to be attaching the namespace to controller 112, in the sense that the attachment enables controller 112 to access the data stored on the attached namespace. Similarly, preventing (or disabling) access to a namespace may be referred to as “detaching” or more specifically, “detaching the namespace”.

### Host Device

Host device 120 may be a computer system, computer, laptop, tablet, smartphone, etc. In some examples, host device 120 may include other electronic devices that are configured to host data storage device 110. For example, a smart television, a gaming console, a security camera system, other data recording device, etc. This may be useful for cases where information needs to be written and/or accessed securely based on the respective user.

In some examples, host device 120 may be associated with data storage device 110. For example, host device 120 may be an authorized entity that is registered with data storage device 110. In this sense, host device may be an administrator of data storage device 110. In some embodiments, controller 112 may authenticate host device 120. For example, controller 112 may authenticate host device 120 based on a cryptographic method, such as symmetric key cryptography (which may be referred to as secret key cryptography). Such authentication may be based on a challenge-response method, for example, where controller 112 sends a challenge (e.g., random value) to host device 120 and host device generates a response using a shared secret key (such as a signature, cypher, secure hash). Controller 112 receives the response, checks its correctness by comparing the response against an expected response calculated using the same shared secret key stored on the data storage device 110. If both match, the host device 120 is authenticated.

Conditional on data provided by host device 120 based on a secret, controller 112 provides access to protected logical storage space 117. In the context of the present disclosure, a secret (which may be referred to as a shared secret) may refer to data that is to be kept confidential between the data storage device 110 (more specifically, controller 112) and host device 120. For example, both host device 120 and data storage device 110 may comprises a cryptographic key and the secret may be based on the cryptographic key. The secret may simply be the cryptographic key multiplied by a larger number (which may be referred to as a generator). Hence, even if the secret is acquired by an untrusted entity, the untrusted entity cannot determine the cryptographic key. The cryptographic key may be based on Diffie-Hellman, Kerberos or another type of encryption.

Once authenticated, controller 112 provides access to protected logical storage space 117, meaning that host device 120 may access protected logical storage space 117 and the protected resources therewithin (e.g., controller 112 attaches the namespace corresponding to protected logical storage space 117). Controller 112 may also prevent (or disable) access to protected logical storage space 117 after authentication. For example, controller 112 may receive communication for host device 120 instructing controller 112 to prevent access. As such, once authenticated, host device 120 may configure access to protected logical storage space 117 (i.e., host device 120 may enable or disable access, once authenticated). Host device 120 may also have read and write access to protected logical storage space 117, meaning that host device 120 may add or remove data that is stored on protected logical storage space 117.

### User Device

Similar to host device 120, user device 130 may be a computer system, computer, laptop, tablet, smartphone, etc. In some examples, host device 120 may include other electronic devices that is configured to host data storage device 110. For example, a smart television, a gaming console, a security camera system, other data recording device, etc. In essence, user device 130 may be a device associated with an end-user, such as a personal computer.

Although, user device 130 may communicatively couple with data storage device 110 (and thus, with controller 112), protected logical storage space 117 is generally inaccessible to user device 130. In other words, controller 112 does not provide access to protected logical storage space 117 from user device 130 (e.g., the namespace corresponding to protected logical storage space 117 is detached). Controller 112 may determine that user device 130 is not an authorized or registered entity of data storage device 110. For example, controller 112 may transmit a secret (e.g., based on a cryptographic key) to user device 130, but controller 112 may not authorize user device 130 as user device 130 cannot transmit the correct response.

### Volatile Memory

Data storage device 110 comprises volatile memory 118, which may be used to temporarily store data during an operating session of data storage device 110. This can include firmware and a secret, for example. Volatile memory 118 may be cache, processor register, random access memory (RAM) or another equivalent type of memory. In some examples, volatile memory 118 includes a dynamic random-access memory (DRAM) chip. However, it is noted that other embodiments of data storage device 110 may not include volatile memory 118.

### Power Source

Data storage device 110 may comprise power source 119, which is configured to provide power to data storage device 110. In particular, power source 119 is configured to provide power to data storage device 110 when uncoupled (or disconnected) or in an uncoupled state from host device 120 and/or user device 130. As such, power is maintained to components of data storage device 110, such as controller 112 and volatile memory 118, enabling these components to continue operations when uncoupled (or disconnected) or in an uncoupled state from host device 120 and/or user device 130. Power source 119 may be a battery, capacitor, or the like. However, it is noted that other embodiments of data storage device 110 may not include power source 119. For example, host device 120 and/or user device 130 may provide power to data storage device 110 (and its components) while being communicatively coupled. In some examples, power source 119 supplies a small amount of power to data storage device 110 or some components (e.g., controller 112) upon data storage device 110 disconnecting from its primary power source (e.g., from host device 120). As such, power source 119 may be considered to be a “back-up” power source to maintain operation of some components (e.g., controller 112).

### Method

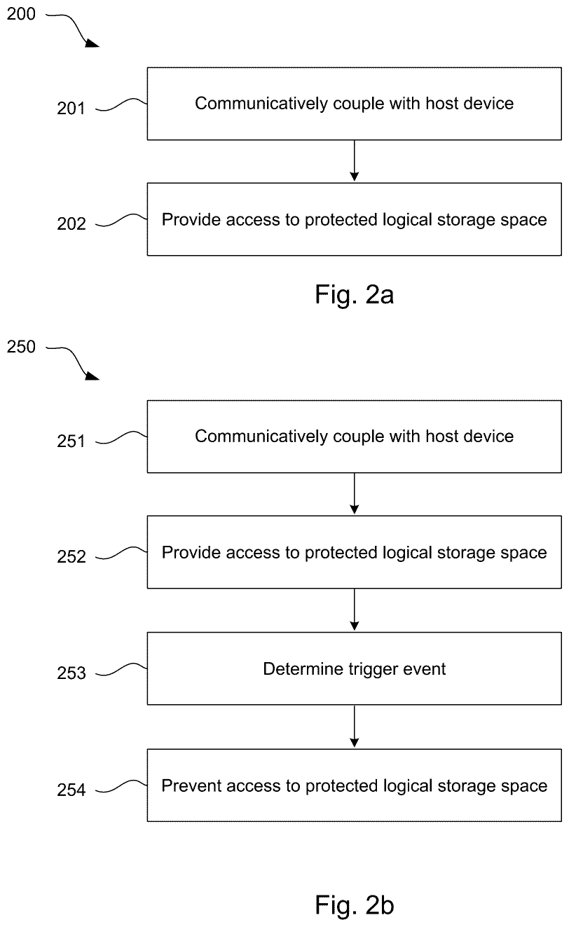

FIG. 2a illustrates an example embodiment of a method (denoted as method 200) performed by at least one controller (e.g., controller 112 of FIG. 1) of data storage device 110. FIG. 2a is to be understood as a blueprint for a software program and may be implemented step-by-step, such that each step in FIG. 2a may be represented by a function in a programming language, such as, but not limited to, Python, C++ or Java. The resulting source code is then compiled and stored as computer-executable instructions on non-volatile memory 114, which causes at least one controller (i.e., controller 112) to perform method 200.

Controller 112 communicatively couples 201 with host device 120. In other words, a communication may be established between controller 112 and host device 120, where data may be transmitted. Conditional on data provided by host device 120 based on a secret, controller 112 provides 202 access to protected logical storage space 117 (e.g., attaches the namespace corresponding to protected logical storage space 117). In other words, controller 112 provides 202 access to protected logical storage space 117 upon authentication of host device 120. Protected logical storage space 117 is a logical storage space of a non-volatile storage medium (i.e., non-volatile memory 114) of data storage device 110 and is inaccessible at power-up of data storage device 110 (e.g., the namespace corresponding to protected logical storage space 117 is detached). “Power-up” may refer to when data storage device 110 is coupled to host device 120 and/or user device 130 (for example, in the embodiments of data storage device 110, where the device is powered by host device 120 or user device 130).

Further, protected logical storage space 117 becomes inaccessible in response to a trigger event (e.g., controller 112 detaches the namespace corresponding to protected logical storage space 117). In the context of the present disclosure, “trigger event” may refer to an event or occurrence or trigger to warrant a lockdown of protected logical storage space 117. For example, a “trigger event” may refers to an event or occurrence that would transition data storage device 110 from a secured or trusted state (e.g., verified authentication of host device 120) to an unsecured or untrusted state (e.g., host device 120 is no longer authenticated). In one example, and as explained below, a trigger event may be uncoupling or disconnecting host device 120 and data storage device 110. Responding to the trigger event may ensure that access to protected logical storage space 117 is prevented. For example, this ensures that user device 130 cannot access the protected resources stored on protected logical storage space 117 upon decoupling of data storage device 110 with host device 120.

It is noted that, in some embodiments, controller 112 may not explicitly determine the trigger event. For example, the trigger event may be power-off of data storage device 110, due to decoupling or disconnect between data storage device 110 and host device 120. Powering-off the device may cause data that indicates that protected logical storage space 117 is accessible to vanish, i.e., data storage device 110 “forgets” that access to protected logical storage space 117 was enabled. For example, configuration data to access to protected logical storage space 117 may be stored on volatile memory 118 of data storage device 110 and hence, access to protected logical storage space 117 may be lost on power-down of data storage device 110. Hence, in some embodiments, controller 112 does not explicitly determine the trigger event and/or make protected logical storage space inaccessible.

FIG. 2b illustrates another example embodiment of a method (denoted as method 250) performed by at least one controller (e.g., controller 112 of FIG. 1) of data storage device 110, which is similar to method 200 of FIG. 2a. In particular, 251 and 252 of method 250 may be similar or equivalent to 201 and 202 of method 200, respectively.

Controller 112 determines 253 a trigger event. In this case, controller 112 explicitly determines the trigger event. For example, host device 120 may cause a controller-level reset of controller 112, in response to transmission received from host device 120. As such, the trigger event may be the controller-level reset and controller 112 may determine this trigger event before resetting. In another example, communication may be lost between host device 120 and data storage device 110, which may correspond to a trigger event in this example. As such, controller 112 may determine this trigger event upon loss of communication with host device 120. In this example, controller may rely on power from power source 119 to continue operating upon loss of communication (and hence, loss of a powered connection) between host device 120. In a sense, a trigger event may be an event that makes data storage device 110 vulnerable.

Controller 112 prevents 254 access to protected logical storage space 117, upon determining the trigger event (e.g., detaches the namespace corresponding to protected logical storage space 117). For example, controller 112 may only enable access to a logical storage space that is not protected logical storage space 117 (e.g., logical storage spaces 115, 116). This means that protected logical storage space 117 becomes inaccessible in response to an event that would otherwise leave protected logical storage space 117 accessible.

In some examples, controller 112 explicitly determines whether protected logical storage space 117 is accessible. In these examples, upon determining that protected logical storage space 117 is accessible and upon determining a trigger event, controller 112 prevents access to protected logical storage space 117 (e.g., controller 112 makes protected logical storage space inaccessible). As such, if controller 112 determines that protected logical storage space 117 is inaccessible, then, upon determining a trigger event, controller 112 may simply not respond, in some examples.

### Trigger Event

In some embodiments, the trigger event is power-down of data storage device 110. For example, data storage device 110 may rely on power from host device 120. In this example, host device 120 may power down or data storage device 110 and host device 120 may decouple (or disconnect). As such, controller 112 may determine power-down of data storage device 110, thereby determining a trigger event. In these cases, controller 112 may receive communication from host device 120 indicating power-down of host device 120. Similarly, controller 112 may receive a command (in the form of a communication) from host device 120 instructing a power-down of data storage device 110. As such, controller 112 may receive such communication, determine a trigger event and prevent access to protected logical storage space before data storage device 110 powers down.

In some embodiments, the trigger event is a reset of controller 112. For example, the trigger event may correspond to a device reset, an indication that the user has unmounted data storage device 110, a controller-level reset or initiation of a power cycle of data storage device 110. In some examples, controller 112 may receive a command (in the form of a communication) from host device 120 instructing a reset of controller 112 or data storage device 110, or to commence a power cycle. As such, controller 112 may receive such communication, determine a trigger event and prevent access to protected logical storage space 117 before resetting. In this sense, host device 120 implicitly prevents protected logical storage space 117 from being accessible. In other examples, data storage device 110 may be decoupled from host device 120 and/or user device 130 (e.g., in a disconnected or decoupled state) and controller 112 may determine a reset (e.g., of controller 112) or a power cycle is warranted. As such, controller 112 may determine a trigger event (corresponding to the warranted reset) and prevent access to protected logical storage space before resetting. In this example, controller 112 may rely on power from power source 119 or may determine the trigger event the next time it is powered.

In some embodiments, the trigger event is a transfer of control to an OS (e.g., Windows, Linux, macOS, DOS, Unix, iOS and Android). In some cases, protected resources and other data stored on protected logical storage space 117 are to be segregated and shielded from untrusted software, e.g., anything that runs on top of an OS. As such, when the BIOS is ready to hand off control to the OS, controller 112 may prevent access to protected logical storage space 117 before the OS gains control. In some examples, controller 112 may receive communication from host device 120 indicating that BIOS is ready to hand off control to the OS. As such, controller 112 may receive such communication, determine a trigger event and prevent access to protected logical storage space before data storage device 110 powers down. Host device 120 may also cause controller 112 or data storage device 110 to reset before handing off control to the OS. As such, controller may prevent access to protected logical storage space 117 in a similar manner as described above. One application for this behavior may be to provide data to the BIOS, such as cryptographic keys or certificates, which should not be available to the OS.

In some embodiments, the trigger event is receiving user input data. For example, a user associated with host device 120 may explicitly prevent access to protected logical storage space 117. In this sense, host device 120 explicitly prevents protected logical storage space 117 from being accessible. It is noted that host device 120 may configure access to protected logical storage space 117 (i.e., enable or disable access to this logical storage space), if authorized and authenticated by controller 112. In some examples, controller 112 may receive a command (in the form of a communication) from host device 120 instructing controller 112 to prevent (or disable) access to protected logical storage space 117 (e.g., detach namespace). Such command may be indicative of user input data. As such, controller 112 may receive such communication, determine a trigger event and prevent access to protected logical storage space in response to the command.

In some embodiments, the trigger event is power-up of data storage device 110. For example, data storage device 110 may be decoupled (or disconnected) from host device 120. In this example, data storage device 110 may not have an internal power supply (such as power source 119) and hence, controller 112 may rely on power from host device 120 and/or user device 130. As such, protected logical storage space 117 may have been accessible when decoupled (or disconnected) from host device 120. However, when coupled (or connected) to host device 120 and/or user device 130, controller 112 may regain power and determine a trigger event, corresponding to the power-up of data storage device 110. Hence, controller 112 may prevent access to protected logical storage space 117, such that protected logical storage space 117 is inaccessible at power-up of data storage device 110.

### Device States

In some embodiments, controller 112 is further configured to configure data storage device 110 into one of multiple device states. Each of the multiple device states may be indicative of access to one or more of the logical storage spaces (e.g., logical storage spaces 115, 116, 117 with reference to FIG. 1). For example, there may be a device state where protected logical storage space 117 is accessible, and there may be another device state with protected logical storage space 117 is inaccessible. More explicitly, conditional on data provided by host device 120 based on a secret, controller 112 may configure data storage device 110 into one of multiple device states. In other words, host device 120 may configure (or change) the device state of data storage device 110 if authorized and authenticated by controller 112. In this context, “device state” may refer to a (changeable) configuration of the data storage device 110. “Configuring” the device state, in the present context, may refer to transitioning, switching, changing, swapping etc. the current device state to a different device state.

As host device 120 may configure the device state of data storage device 110, host device 120 may explicitly configure (in other words, transition, switch, change or the like) data storage device 110 from one device state to another device state. For example, controller 112 may receive a command (in the form of a communication) from host device 120 instructing controller 112 to configure data storage device 110 from one device state to another device state. As such, controller 112 may configure data storage device 110 from one device state to another device state by configuring (or changing) the accessibility (e.g., enable or disable access) of one or more logical storage spaces. Configuring the accessibility of one or more logical storage spaces may also include changing the read-and-write access properties of one or more logical storage spaces.

In some examples, one or more of the multiple device states may be locked (or frozen) by controller 112 (in response to communication received from host device 120, for example). This means that, if data storage device 110 is decoupled (or disconnected) from host device 120 and/or data storage device 110 loses power (e.g., the device powers-down or resets), then data storage device 110 may remain in the assigned device state until host device 120 re-configures data storage device 110 into a different device state. As such, some logical storage spaces may remain accessible, even upon data storage device powering-down.

In some embodiments, the multiple device states comprise a device state where protected logical storage space 117 is accessible (e.g., the corresponding namespace attached) (such as read-and-write accessible). This device state may be referred to as the hidden device state, protected device state or the like. It is noted that, as protected logical storage space 117 is inaccessible at power-up of data storage device 110, controller 112 may be configured to ensure data storage device 110 is out of the hidden device state at power-up of data storage device 110. For example, controller 112 may determine a trigger event and configure data storage device 110 so that it is out of the hidden device state at power-up of data storage device 110. In one example, if data storage device 110 is in the hidden device state and controller 112 determines a trigger event, controller 112 may configure data storage device 110 into a device state where protected logical storage space is inaccessible.

In some embodiments, one or more of the multiple device states are non-transient. In particular, in some embodiments, the hidden device state is non-transient. This may mean that non-volatile memory 114 stores and maintains these states (and any data stored on the associated logical storage spaces) even if data storage device 110 is re-configured into a different device state, data storage device 110 powers down, data storage device 110 decouples from host device 120 and/or user device 130. For example, if the hidden device state is non-transient, then non-volatile memory 114 may store and maintain this state (and the protected resources stored on protected logical storage space 117) even if a trigger event occurs. Conversely, one or more of the multiple device states may be transient, in the sense that the device state is “forgotten” upon re-configuring data storage device 110 to a different device state or the like.

In some embodiments, the logical storage spaces comprise a default logical storage space indicative of manufacturing default conditions of data storage device 110. For example, with reference to FIG. 1, logical storage space 115 may be the default logical storage space. The default logical storage space may be configured to store user data, such as data associated with user device 130. In these embodiments, the multiple device states comprise a default device state where the default logical storage space (e.g., logical storage space 115) is accessible (e.g., namespace attached) and protected logical storage space 117 is inaccessible (e.g., namespace detached). For example, data storage device 110 that is configured in the default device state may appear as a formatted and/or default storage device when coupled to host device 120 and/or user device 130.

In some embodiments, controller 112 configures data storage device 110 into the default device state in response to the trigger event. For example, controller 112 may determine a trigger event, then configure (i.e., transition, switch, swap, change or the like) data storage device 110 into the default device state regardless of its prior device state. This is particularly advantageous if data storage device 110 was configured in the hidden device state prior to the trigger event. For example, this ensures that protected logical storage space 117 is inaccessible in response to a trigger event. In some embodiments, if data storage device 110 is configured in the hidden device state, then controller 112 configures data storage device 110 into the default device state in response to the trigger event. In other words, controller 112 may not configure data storage device 110 in response to a trigger event, if data storage device 110 is in a device state other than the hidden device state.

In some embodiments, the multiple device states comprise a device state where one or more of the logical storage spaces is read-only accessible. This device state may be referred to as a user device state, or the like. Similarly, in some embodiments, the multiple device states comprise a device state where each of the logical storage spaces are read-and-write accessible. This device state may be referred to as an admin device state, or the like, as this state is indicative of administrator access of data storage device 110.

As previously discussed, both host device 120 and data storage device 110 may comprise a cryptographic key and the secret may be based on the cryptographic key. In other words, controller 112 may authenticate host device 120 based on the cryptographic key. However, in some embodiments, the cryptographic key is one of multiple cryptographic keys each associated with one of multiple device states of data storage device 110. As such, in some embodiments, controller 112 is further configured to configure data storage device 110 into one of multiple device states associated with the cryptographic key. A device state may be considered to be “frozen” or “locked”, until controller 112 authenticated host device 120 using the associated cryptographic key, which may be referred to as “unfreezing” or “unlocking” the device state. It is noted that other device states that are not associated with that particular cryptographic key may remain “frozen” or “locked” during this process.

For example, host device 120 may comprise cryptographic keys associated with the hidden device state and the admin device state. However, a further host device (which may be registered with data storage device 110) may comprise the cryptographic key associated with the hidden device state, but not the admin device state. Therefore, host device 120 can configure (e.g. transition, switch, change, or the like) data storage device 110 into the hidden device state or the admin device state. However, the further host device can only configure data storage device 110 into the hidden device state. In some examples, the default device state may not be associated with a cryptographic key, so that any host device can configure data storage device 110 into default device state. However, in these examples, the host device may still be authenticated by controller 112.

In some examples, the multiple device states are “personalities” according to an NVMe protocol. In particular, NVMe may include a feature called “Device Personalities”. This feature enables a data storage device to maintain multiple feature sets controllable by a secure entity (not necessarily the user) such as host device 120. For example, in the general use case, a data storage device may be switched from a self-encrypting device (i.e., one personality) to an unsecured device (i.e., another personality) and vice-versa. This may be useful for device manufacturers to re-configure data storage devices or use the same data storage device for different purposes.

As such, the hidden device state may be referred to as a hidden personality or Hidden Proprietary Personality (HPP). Further, the default device state may be referred to as the default personality or Manufacturing Default Personality (MDP), which may be similar to the MDP defined in the NVMe specification. As the MDP may be seen as the default or factory conditions of data storage device 110, configuring data storage device 110 from the HPP to the MDP may be referred to as “reverting” or more specifically, “reverting the device”. Configuring data storage device 110 from the HPP to the MDP may be referred to as “resetting” or more specifically, “resetting the (data storage) device” and may involve detaching the namespace corresponding to the protected logical storage space 117.

As discussed above, in some embodiments, controller 112 configures data storage device 110 into the default device state in response to the trigger event. If the device states are considered to be “personalities”, then, in some embodiments, controller 112 may configure data storage device 110 into the MDP in response to the trigger event. As such, the data storage device of this disclosure may be referred to as a “self-resetting hidden device personality” in the sense that the disclosed data storage device “resets” by reverting to the MDP in response to a trigger event.

It is noted that the “personalities” according to the NVMe protocol, are non-transient (i.e., persistent). In other words, a data storage device (not necessarily the data storage device according to the present disclosure) configured with a device personality maintains this personality until a host device re-configures the device into a different personality. As such, a data storage device configured with a HPP maintains this personality, even if the data storage device is put in an unsecured or untrusted environment, which may make a protected logical storage space accessible to an untrusted entity. The embodiments of the disclosed data storage device aim to address this. In essence, the embodiments of the disclosed data storage device may use a similar infrastructure to the “personalities” infrastructure, but for a different purpose. Essentially, the embodiments of the disclosed data storage device may provide a personality with features, such as access to a specific namespace, but this personality is prevented from being activated except when a trusted entity requests this.

### Example Embodiments of Data Storage Device

Data Storage Device with Namespaces

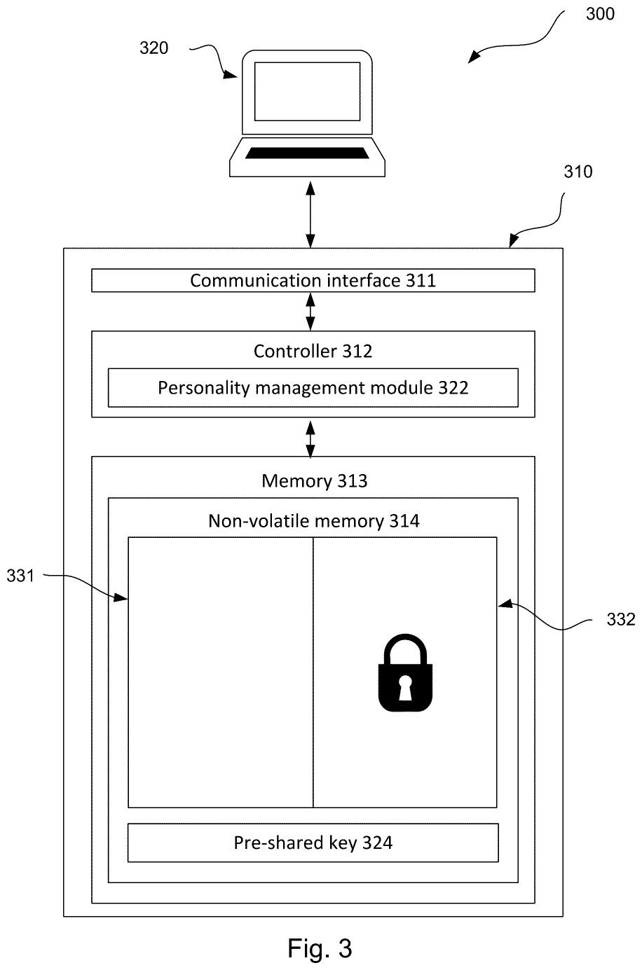

FIG. 3 illustrates an example system (denoted as system 300), according to an embodiment of the present disclosure. More specifically, FIG. 3 shows an example embodiment of a data storage device (denoted as data storage device 310), according to the present disclosure. It is noted that data storage device 310 of FIG. 3 may be similar (and hence, have similar functions and components) as data storage device 110 of FIG. 1. As such, some embodiments and examples described above in relation to data storage device 110 may be similar or equivalent embodiments and examples of data storage device 310.

In this example embodiment, non-volatile memory comprises two logical storage spaces. In this example embodiments, the two logical storage spaces are namespaces according to NVMe (denoted as namespace 331 and namespace 332). Protected resources, such as secure data, are stored in namespace 332, as indicated in FIG. 3. As such, namespace 332 may be considered to be a protected logical storage space. In this example embodiment, each namespace is associated with a device personality, according to NVMe. In other words, each personality has its own namespace assignments. One personality is referred to as the Manufacturing Default Personality (MDP) and the other personality is referred to as Hidden Proprietary Personality (HPP).

In the MDP, namespace 331 is attached and namespace management is disabled, preventing access to namespace 332. In the HPP, both namespaces are available (i.e., both namespaces 331, 332 are attached) and namespace management is available to host device 320. Controller 312 comprises a personality management module 322, which may manage the two personalities e.g., personality management module 322 may be used to configure (e.g., transition, switch, change etc.) data storage device 310 from one personality to the other and may be used to configure the feature set stored on namespace 332. Personality management module 322 may use pre-shared key 324 (i.e., a cryptographic key) stored on non-volatile memory 314 to authenticate the secure environment (e.g., to authenticate host device 320).

In this example embodiment, controller 312 may cause namespace 332 to become inaccessible in response to a trigger event. For example, controller 312 may determine a device reset, power cycle of data storage device 310, or loss of communication with host device 320. As such, if data storage device 310 was configured in the HPP when the trigger event occurs, then controller 312 (more specifically, personality management module 322) may revert data storage device 310 from the HPP to the MDP. Thus, namespace 332 (i.e., the protected logical storage space) becomes inaccessible in response to a trigger event.

### Example of Host-Device Interactions

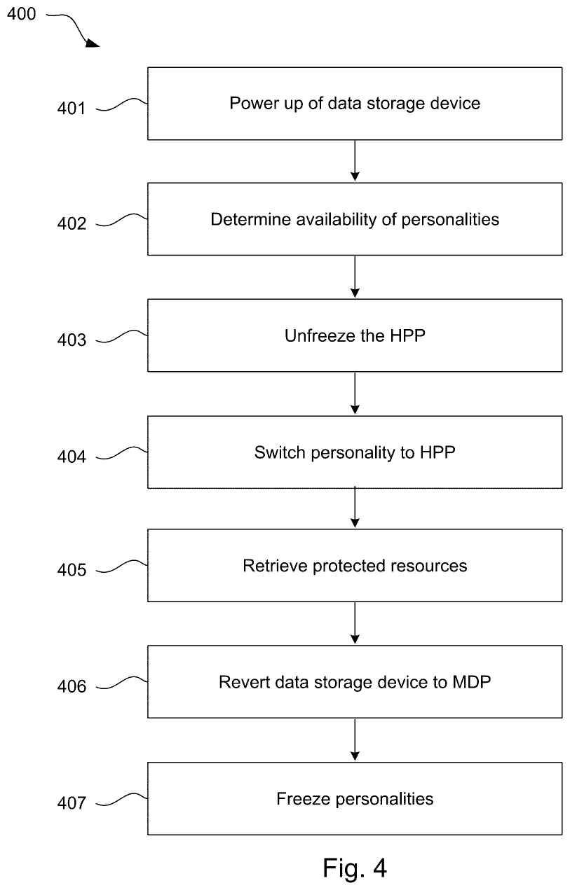

FIG. 4 shows a flowchart of interactions between a host device and an embodiment of the data storage device, according to the present disclosure. This will be explained with reference to data storage device 310 of FIG. 3. It is noted that each stage of the flowchart of FIG. 4 may not occur in each interaction between a host device and the disclosed data storage device. FIG. 4 is an example of a flow process to illustrate the interaction between a host device and the disclosed data storage device.

At 401, data storage device 310 powers-up. For example, data storage device 310 may be coupled to host device 320, and the coupling may initiate a power-up of data storage device. On power-up, data storage device 310 is in the MDP or the MDP is applied. As such, namespace 332 (i.e., the protected logical storage space) is inaccessible at power-up of data storage device 310. At this stage, the personalities are considered to be frozen, meaning that the personalities cannot be configured (e.g., switched).

At 402, host device 320 determines the availability of personalities. For example, for data storage device 310, host device 320 may determine that the MDP and HPP are available personalities of the device. As such, it may be said that host device 320 enumerates the personalities and determines the availability of the desired personality (e.g., the MDP). Host device 320 may also determine that the personalities are frozen.

At 403, host device 320 unfreezes the HPP. More specifically, controller 312 may authenticate host device 320 using pre-shared key 324 (i.e., a cryptographic key that has been pre-shared with host device 320). Hence, data storage device 310 may be considered to be in a secured or trusted state. By unfreezing the HPP, data storage device 310 may now be configured (e.g., switched) from the MDP to the HPP. Hence, at 404, host device 320 causes data storage device 310 to be configured from the MDP to HPP. For example, host device may use set features to switch the personalities. Host device 320 may enable the HPP using a personality change sequence. As data storage device 310 is now in the HPP, namespace 332 (i.e., the protected logical storage space) is accessible. Hence, at 405, host device 320 may retrieve the protected resources from namespace 332.

At 406, host device 320 reverts data storage device 310 to the MDP. For example, host device 320 may cause data storage device 310 to revert from the HPP to the MDP either implicitly (e.g., cause a controller-level reset of controller 312) or explicitly (e.g., explicitly causing data storage device 310 to transition from the HPP to MDP). Host device 320 may revert data storage device 310 to the MDP before transitioning out of the secure state e.g., decoupling host device 320 and data storage device 310, or when the BIOS is ready to hand off control to the OS (i.e., before loading the OS). If there is a controller-level reset, data storage device 310 will automatically transition back to the MDP. Hence, at 407, the personalities (e.g., HPP) are frozen as a result of transitioning out of the secured state. As such, data storage device 310 remains in the MDP until the HPP is unfrozen and switched. Upon the next reset or power cycle, the HPP will be hidden even if it was left visible. This would protect the data in the private namespace even if data storage device 310 was migrated to an untrusted host. Host device 320 may also use the Lockdown command to prevent access to the personality feature if desired.

Data Storage Device with Multiple Personalities

Another example embodiment will now be explained. Consider an embodiment of the disclosed data storage device which comprises three namespaces (i.e., logical storage space) denoted as NS1, NS2 and NS3. Hence, there may be three device personalities with different access configurations to the three namespaces and each personality may be associated with a pre-shared key (i.e., a cryptographic key). In this example embodiment, the HPP may selectable limited access privileges, depending on which pre-shared key is used. In this use case, there are multiple variants of the HPP with different namespace mappings and access rights to each one. An example of this is shown in Table 1.

TABLE 1
An example of access configurations of the device personalities
in the example embodiments. It is noted that the “user
personality” and the “admin personality”
may be considered as different variants of the HPP.

| | NS1 | NS2 | NS3 | Notes |
|---|---|---|---|---|
| MDP | Attached | Not | Not | Namespace |
| | | attached | attached | management/ |
| | | | | attach disabled |
| User | Attached | Attached, | Not | Namespace |
| Personality | | Read Only | attached | management |
| | | | | enabled, |
| | | | | namespace |
| | | | | write protect |
| | | | | enforced on NS2 |
| Admin | Attached | Attached | Attachable | Full control |
| Personality | | | | |

The use of these personalities with varying access configuration enables limited access to the protected resources. For example, a recovery application with user-specific data may be stored in NS2 and available when the host BIOS determines that recovery is needed, without exposing additional secrets found in NS3. It is noted that these the additional personalities may be transient and MDP is re-applied in response to a trigger event (e.g., a controller-level reset).

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited.

Similarly, it is to be noticed that the term connected, when used in the claims, should not be interpreted as being limited to direct connections or couplings only. The term “connected”, along with its derivatives, may be used. It should be understood that the scope of the expression a device A “connected to” a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still cooperate or interact with each other.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A data storage device comprising:
a non-volatile storage medium configured to store data, the non-volatile storage medium being configurable to comprise logical storage spaces, the logical storage spaces comprising a protected logical storage space that is inaccessible at power-up of the data storage device;
a communication interface configured to enable communication with a host device; and
at least one controller configured, individually or in combination, to:
communicatively couple with the host device; and
conditional on data provided by the host device based on a secret, provide access to the protected logical storage space,
wherein the protected logical storage space becomes inaccessible in response to a trigger event.

2. The data storage device of claim 1, wherein the trigger event is power-down of the data storage device.

3. The data storage device of claim 1, wherein the trigger event is one of:
a reset of the controller;
transferring control to an operating system (OS); and
receiving user input data.

4. The data storage device of claim 1, wherein the at least one controller is further configured to configure the data storage device into one of multiple device states, each of the multiple device states being indicative of access to one or more of the logical storage spaces.

5. The data storage device of claim 4, wherein the multiple device states comprise a hidden device state where the protected logical storage space is read-and-write accessible.

6. The data storage device of claim 5, wherein the hidden device state is non-transient.

7. The data storage device of claim 4, wherein the multiple device states comprise a user device state where the one or more of the logical storage spaces are read-only accessible.

8. The data storage device of claim 4, wherein the multiple device states comprise an admin device state where the each of the logical storage spaces are read-and-write accessible.

9. The data storage device of claim 4, wherein the logical storage spaces comprise a default logical storage space indicative of manufacturing default conditions of the data storage device, and the multiple device states comprise a default device state where the default logical storage space is accessible and the protected logical storage space is inaccessible.

10. The data storage device of claim 9, wherein the data storage device is configured into the default device state in response to the trigger event.

11. The data storage device of claim 4, wherein the multiple device states are device personalities.

12. The data storage device of claim 1, wherein the logical storage spaces are namespaces.

13. The data storage device of claim 1, wherein the non-volatile storage medium comprises a cryptographic key and the secret is based on the cryptographic key.

14. The data storage device of claim 13, wherein
the cryptographic key is one of multiple cryptographic keys each associated with one of multiple device states of the data storage device; and
the at least one controller is further configured to configure the data storage device into one of multiple device states associated with the cryptographic key.

15. The data storage device of claim 1, wherein non-volatile storage medium is configured to store data in the protected logical storage space in a form as received from the host device.

16. The data storage device of claim 1, wherein the non-volatile storage medium is a solid-state drive (SSD).

17. The data storage device of claim 1, wherein the communication interface is configured to communicate with the host device according to NVMe.

18. A method performed by at least one controller of a data storage device, the method comprising:
communicatively coupling with a host device; and
conditional on data provided by the host device based on a secret, providing access to a protected logical storage space, the protected logical storage space being a logical storage space of a non-volatile storage medium of the data storage device and being inaccessible at power-up of the data storage device,
wherein the protected logical storage space becomes inaccessible in response to a trigger event.

19. The method of claim 18, wherein the logical storage space comprises a namespace and the trigger event is power-down of the data storage device.

20. A data storage device comprising:
means for storing user data and means for configuring logical storage spaces of the data storage device, the logical storage spaces comprising a protected logical storage space that is inaccessible at power-up of the data storage device;
means for communicatively coupling with a host device;
means for providing access to the protected logical storage space, conditional on data provided by the host device based on a secret; and
wherein the protected logical storage space becomes inaccessible in response to a trigger event.
